(19) United States
(12) Patent Application Publication
(10) Pub. No.: US 2010/0156721 A1
(43) Pub. Date: Jun. 24, 2010

(54) MILLIMETER-WAVE INDOOR WIRELESS PERSONAL AREA NETWORK WITH CEILING REFLECTOR AND METHODS FOR COMMUNICATING USING MILLIMETER-WAVES

(76) Inventors: Siavash M. Alamouti, Hillsboro, OR (US); Alexander Alexandrovich Maltsev, Nizhny Novgorod (RU); Vadim Sergeyevich Sergeyev, Nizhny Novgorod (RU); Alexander Alexandrovich Maltsev, JR., Nizhny Novgorod (RU)

Correspondence Address: SCHWEGMAN, LUNDBERG & WOESSNER/Intel, PO BOX 2938, MINNEAPOLIS, MN, 55402, US

(21) Appl. No.: 12/301,792

(22) PCT Filed: Jun. 16, 2006
(86) PCT No.: PCT/RU2006/000315

§ 371 Date: Feb. 12, 2010

(51) Int. Cl. H04B 7/145; H01Q 15/14

(52) U.S. Cl. 342/367

(57) ABSTRACT

Embodiments of an indoor millimeter-wave wireless personal area network and method are described. In some embodiments, a directional antenna (103) and a diffusive reflector (106) are used to increase throughput and reduce multipath components.

### RELATED APPLICATIONS

This patent application claims priority to currently pending patent PCT application filed in the Russian receiving office on May 23, 2006 having application serial number [TBD] and attorney docket number 884.H19WO1 (P23949).

This patent application relates to the currently pending patent PCT application filed in the Russian receiving office on May 23, 2006 having attorney docket number 884.H17WO1 (P23947), and to currently pending patent PCT application filed concurrently in the Russian receiving office having attorney docket number 884.H18WO1 (P23948).

### TECHNICAL FIELD

Some embodiments of the present invention pertain to wireless networks that use millimeter-wave frequencies. Some embodiments of the present invention pertain to wireless personal area networks (WPANs) that use millimeter-wave frequencies to communicate.

### BACKGROUND

Many conventional wireless networks communicate using microwave frequencies generally ranging between two and ten gigahertz (GHz). These systems generally employ either omnidirectional or low-directivity antennas primarily because of the comparatively long wavelengths of the frequencies used. The low directivity of these antennas may limit the throughput of such systems making real-time video streaming applications, such as high-definition television (HDTV), difficult to implement. Directional antennas could increase the throughput of these systems, but the wavelength of microwave frequencies make compact directional antennas difficult to implement. The millimeter-wave band may have available spectrum and may be capable of providing even higher-level throughputs. One issue with the use of millimeter-wave frequencies for indoor networking applications is the inability of millimeter-waves to travel around objects making non-line of sight communications difficult. Another issue with the use of millimeter-wave frequencies for indoor network applications is that multipath components make it difficult to process received signals.

Thus, there are general needs for indoor wireless networks with increased throughput and reduced multipath components. There are also general needs for wireless personal area networks with increased throughput suitable for real-time video streaming applications, such as HDTV.

### BRIEF DESCRIPTION OF THE DRAWINGS

FIG. 1 illustrates an indoor millimeter-wave wireless personal area network in accordance with some embodiments of the present invention;

FIG. 2 illustrates an indoor millimeter-wave wireless personal area network with a diffusive reflector in accordance with some other embodiments of the present invention;

FIG. 3 is a block diagram of a millimeter-wave wireless communication device in accordance with some embodiments of the present invention; and

FIG. 4 illustrates a millimeter-wave wireless local area network in accordance with some embodiments of the present invention.

### DETAILED DESCRIPTION

The following description and the drawings sufficiently illustrate specific embodiments of the invention to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in, or substituted for, those of other embodiments. Embodiments of the invention set forth in the claims encompass all available equivalents of those claims. Embodiments of the invention may be referred to herein, individually or collectively, by the term “invention” merely for convenience and without intending to limit the scope of this application to any single invention or inventive concept if more than one is in fact disclosed.

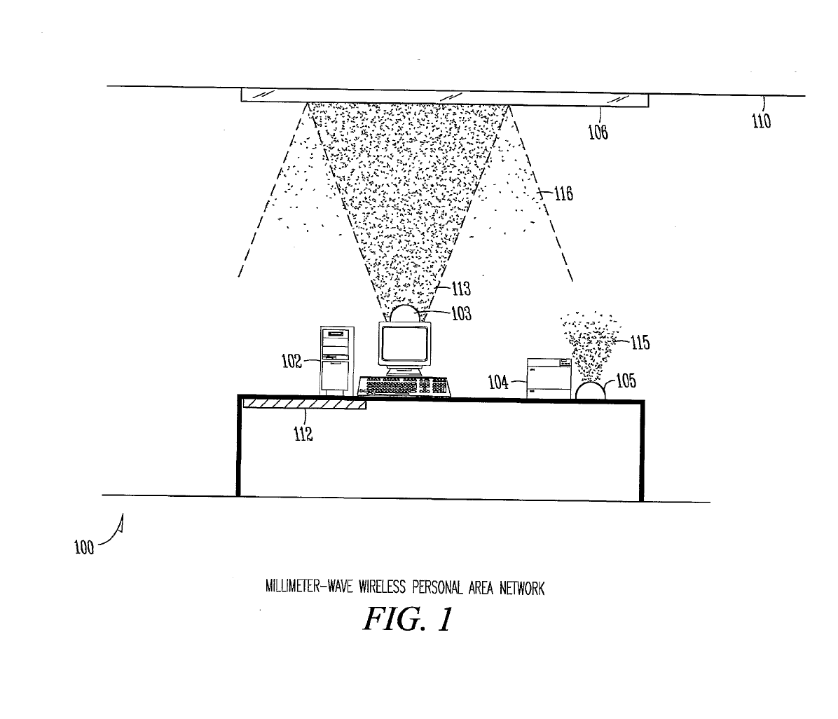

FIG. 1 illustrates an indoor millimeter-wave wireless personal area network in accordance with some embodiments of the present invention. Indoor millimeter-wave wireless personal area network 100 includes wireless communication device 102 and reflector 106 to reflect millimeter-wave signals communicated between wireless communication device 102 and one or more secondary wireless communication devices 104. Reflector 106 may be positioned on either a wall or a ceiling spaced away from wireless communication device 102. Wireless communication device 102 may communicate using directional antenna 103, and secondary wireless communication device 104 may communicate using directional antenna 105, although the scope of the invention is not limited in this respect.

As illustrated, wireless communication device 102 uses directional antenna 103 to direct antenna beam 113 toward reflector 106 which generates reflected beam 116. Reflected beam 116 may be received by secondary wireless communication device 104 through antenna 105. As illustrated, antenna 105 may provide antenna beam 115 which may be directed toward reflector 106 for receiving signals within reflected beam 116. Antenna beams 113 and 115 may refer to the antenna patterns resulting from the directivity of directional antennas 103 and 105, respectively.

Although some embodiments describe millimeter-wave wireless personal area network 100 as an indoor network, the scope of the invention is not limited in this respect as it may be equally applicable to outdoor usage. In some embodiments, wireless communication device 102 may be a personal computer, although other wireless devices may also be suitable. Examples of secondary wireless communication devices 104 may include printers, copiers, scanners, and other peripheral components, although the scope of the invention is not limited in this respect. Other examples of wireless communication device 102 and secondary wireless communication devices 104 are discussed below. In some embodiments, wireless communication device 102 may be viewed as a client device, and secondary wireless communication device 104 may be viewed as a server device, although the scope of the invention is not limited in this respect. In some embodiments, secondary wireless communication devices 104 may include multimedia devices such as digital cameras, camcorders, music players, set-top boxes, game consoles and HDTVs, although the scope of the invention is not limited in this respect.

In some embodiments, directional antenna 103 may have directivity sufficient to allow receipt of millimeter-wave signals through a propagation channel that includes reflector 106. The directivity may also be sufficient to exclude some or most of the multipath components of the millimeter-wave signals from outside the propagation channel, although the scope of the invention is not limited in this respect.

In these embodiments, the propagation channel may comprise a communication path between wireless communication device 102 and secondary wireless communication device 104 that includes reflector 106. The propagation channel may exclude a direct communication path between wireless communication device 102 and secondary wireless communication device 104, although the scope of the invention is not limited in this respect. In these embodiments, the directivity of directional antenna 103 may be sufficient to inhibit direct receipt of millimeter-wave signals from secondary wireless communication device 104. In some embodiments, the propagation channel may include reflector 106 thereby avoiding obstacles directly between wireless communication device 102 and secondary wireless communication device 104, although the scope of the invention is not limited in this respect. In some embodiments, the directivity of directional antenna 103 may help reduce the receipt of multipath components of the millimeter-wave signals, although the scope of the invention is not limited in this respect.

In some embodiments, directional antennas 103 and 105 may be positioned to have an increased directivity in the upward direction. For example, in some embodiments, directional antennas 103 and 105 may be able to be positioned or directed by users to be directed upward to reflector 106, although the scope of the invention is not limited in this respect.

In some embodiments, when antennas 103 and 105 are directed upwards, the propagation channel may be substantially free of obstacles. This may help reduce multipath components and may help simplify demodulation of the signals. In some embodiments, for a ceiling height of approximately three meters and an intended use area having a radius of about three meters around reflector 106, a beamwidth of reflected beam 116 may substantially cover the intended use area. In these embodiments, directional antennas 103 and 105 may respectively provide antenna beams 113 and 115 having a beamwidth of about sixty degrees, although the scope of the invention is not limited in this respect.

In some embodiments, reflector 106 may comprise one or more metallic reflectors, dielectric reflectors comprising dielectric material, dielectric-metallic reflectors comprising a dielectric material with a metallic coating, metallic mesh structures, or dielectric-metallic reflectors. The dielectric-metallic reflectors may comprise a plurality of metallic elements positioned on a dielectric material having a spacing and a length selected to reflect a predetermined millimeter-wave frequency, although the scope of the invention is not limited in this respect.

In some embodiments, reflector 106 may be a metallic plate and may be substantially flat in either a horizontal plane when positioned on the ceiling 110 or a vertical plane when positioned on the wall. In some embodiments, reflector 106 may be located below ceiling 110 as shown, or on a wall. In some other embodiments, reflector 106 may be substantially flat in the horizontal plane and may be located on an upper side of a false ceiling that is substantially transparent to millimeter-wave signals. In some other embodiments, reflector 106 may be located on an outer side of a wall that may be substantially transparent to millimeter-wave signals. These embodiments may allow reflector 106 to be hidden from view, although the scope of the invention is not limited in this respect.

In some embodiments, reflector 106 may be a diffusive reflector, although the scope of the invention is not limited in this respect. Some of these embodiments are discussed in more detail below.

In some embodiments, directional antenna 103 and/or directional antenna 105 may comprise phased array antennas, lens antennas, horn antennas, reflector antennas, slot antennas, and/or slotted-waveguide antennas, although the scope of the invention is not limited in this respect as other directional antennas may also be suitable. In some embodiments, directional antenna 103 and/or directional antenna 105 may be positioned by a user to provide increased directivity in the direction of reflector 106. In some embodiments, directional antenna 103 and directional antennas 105 may be located within non-line of site (i.e., the shadows) of each other allowing communications to take place over the propagation channel that includes reflector 106.

In some embodiments, directional antenna 103 and/or directional antenna 105 may be a chip-lens array antenna comprising a millimeter-wave lens and a chip-array. The chip-array may generate an incident beam of millimeter-wave signals through the millimeter-wave lens. The chip-array may comprise either a linear or planar array of antenna elements coupled to a millimeter-wave signal path, although the scope of the invention is not limited in this respect. In some embodiments, the millimeter-wave lens may comprise millimeter-wave refractive material.

In some embodiments, directional antenna 103 and/or directional antenna 105 may be a chip-lens array antenna comprising a chip-array and millimeter-wave refractive material disposed over the chip-array. In these embodiments, the chip-array may generate and direct millimeter-wave signals within the millimeter-wave refractive material. The chip-array may comprise either a linear or planar array of antenna elements coupled to a millimeter-wave signal path, although the scope of the invention is not limited in this respect. In some embodiments, the millimeter-wave refractive material may narrow a beamwidth of signals generated by the array of antenna elements, although the scope of the invention is not limited in this respect.

In some embodiments, directional antenna 103 and/or directional antenna 105 may be an electronically steerable antenna. In some embodiments when directional antenna 103 and/or directional antenna 105 is a chip-lens array antenna, the array of antenna elements may be coupled to beam-steering circuitry (discussed in more detail below) to direct an incident beam within the millimeter-wave lens for directing millimeter-wave signals from directional antenna 103 to reflector 106, although the scope of the invention is not limited in this respect. As used herein, the term “directing signals” may refer to both the transmission and reception of signals by an antenna.

In some embodiments, directional antenna 103 and/or directional antenna 105 may be a chip-array reflector antenna comprising a chip-array and millimeter-wave reflector. In these embodiments, the chip-array may direct in incident beam for reflection by the millimeter-wave reflector to generate a directional and/or steerable antenna beam.

In some embodiments, directional antenna 103 and/or directional antenna 105 may be directed and/or steered toward reflector 106 to inhibit the receipt of millimeter- wave signals from outside the propagation channel. Signals from outside the propagation channel may include signals received directly from secondary wireless communication devices 104 without utilizing millimeter-wave reflector 106, although the scope of the invention is not limited in this respect.

In some embodiments, absorptive elements 112 may be used to absorb millimeter-wave frequencies within a room to help reduce multipath components of the millimeter-wave signals communicated between the primary wireless communication device 102 and secondary wireless communication device 104. Although directive antenna 103 may help reduce the receipt of multipath components, these embodiments that use absorptive elements 112 may further reduce the receipt of multipath components, although the scope of the invention is not limited in this respect. In some embodiments, antennas of higher directivity may be used to further reduce the receipt of multipath components, although the scope of the invention is not limited in this respect. In some embodiments, absorptive elements 112 may help create an ideal additive white

Gaussian noise (AWGN) communication channel between the primary and secondary wireless communication devices, although the scope of the invention is not limited in this respect. In some embodiments, at least some of the absorptive elements 112 include absorptive material within office furniture.

In some embodiments, the directivity of directional antenna 103 may be selected, controlled, and/or changed responsively based on network characteristics. For example, the directivity of directional antenna 103 may be based on a distance and/or angle to reflector 106, the height of reflector 106, the coverage area of millimeter-wave wireless personal area network 100, and/or the amount of multipath components that result, although the scope of the invention is not limited in this respect.

In some embodiments, the millimeter-wave signals communicated between wireless communication device 102 and secondary wireless communication device 104 may comprise multicarrier millimeter-wave signals having a plurality of substantially orthogonal subcarriers. In some embodiments, the multicarrier millimeter-wave signals may comprise orthogonal frequency division multiplexed (OFDM) signals at millimeter-wave frequencies, although the scope of the invention is not limited in this respect.

In some other embodiments, the millimeter-wave signals communicated between wireless communication device and secondary wireless communication device 104 may comprise spread-spectrum signals, although the scope of the invention is not limited in this respect. In some alternate embodiments, single-carrier signals may be used. In some of these embodiments, single carrier signals with frequency domain equalization (SC-FDE) using a cyclic extension guard interval may also be used, although the scope of the invention is not limited in this respect.

In some embodiments, an extended guard interval may be used to help process multipath components received from outside the propagation channel comprising reflector 106. The use of millimeter-wave signals with extended guard intervals may be particular helpful when directional antenna 105 of secondary wireless communication device 104 is less directional allowing the receipt of some multipath components. In some embodiments, the millimeter-wave signals may comprise packetized communications that may implement a transmission control protocol (TCP) and/or an internet protocol (IP), such as the TCP/IP networking protocol, although other network protocols may also be used. The millimeter-wave frequencies may comprise signals between approximately 57 and 90 gigahertz (GHz).

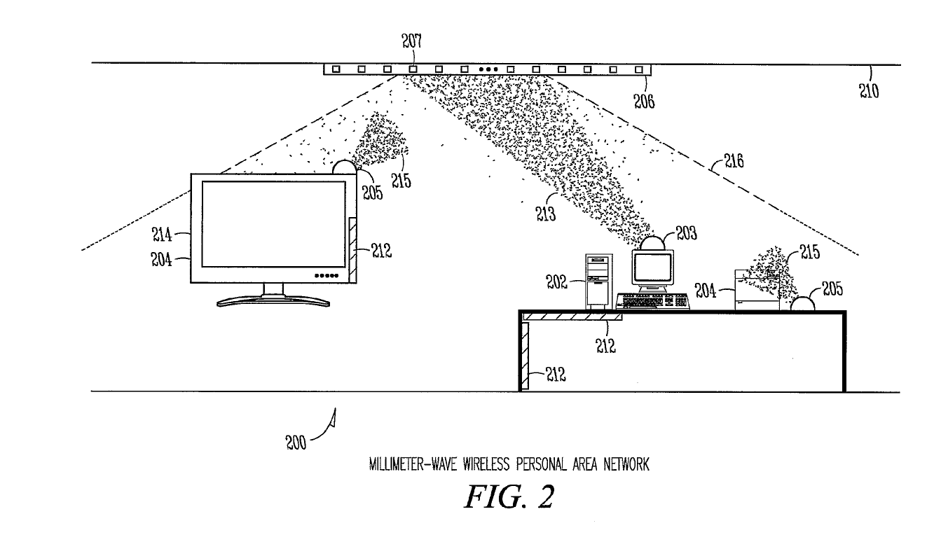

FIG. 2 illustrates an indoor millimeter-wave wireless personal area network with a diffusive reflector in accordance with some other embodiments of the present invention. Indoor millimeter-wave wireless personal area network 200 includes wireless communication device 202, and diffusive reflector 206 to reflect millimeter-wave signals communicated between wireless communication device 202 and one or more secondary wireless communication devices 204. Diffusive reflector 206 may be positioned on either a wall or a ceiling spaced away from wireless communication device 202.

As illustrated, wireless communication device 202 uses directional antenna 203 to direct antenna beam 213 toward diffusive reflector 206 which generates reflected beam 216. Reflected beam 216 may be received by secondary wireless communication devices 204 through directional antennas 205. As illustrated, directional antennas 205 may provide antenna beams 215 which may be directed toward diffusive reflector 206 for receiving signals within reflected beam 216. Antenna beams 213 and 215 may refer to the antenna patterns resulting from the directivity of directional antennas 203 and 205, respectively. Due to the diffusive operation of diffusive reflector 206, reflected beam 216 may cover a larger area than reflective beam 116 (FIG. 1), although the scope of the invention is not limited in this respect.

In these embodiments, wireless communication device 202 may correspond to wireless communication device 102 (FIG. 1) and secondary wireless communication devices 204 may correspond to secondary wireless communication device 104 (FIG. 1). In some embodiments, diffusive reflector 206 may comprise a plurality of diffusive elements 207 to diffuse and reflect millimeter waves. In some embodiments, diffusive elements 207 may comprise half-wavelength dipoles at a predetermined millimeter- wave frequency, although the scope of the invention is not limited in this respect. In some embodiments, diffusive elements 207 may have a substantially uniform spacing therebetween and may be distributed over a dielectric material. In these embodiments, diffusive reflector 206 may diffuse and reflect millimeter-wave signals over a wider area than a non-diffusive reflector, such as reflector 106 (FIG. 1). In these embodiments, directional antenna 203 may be a steerable directional antenna that may be steered toward diffusive reflector 206 in response to receipt of the millimeter-wave signals reflected from diffusive reflector. 206 from at least one of secondary communication devices 204, although the scope of the invention is not limited in this respect.

In some embodiments, diffusive reflector 206 may be frequency-selective allowing at least certain frequencies within the millimeter-wave frequency band to be reflected and diffused while having little or no effect on other frequencies. The use of diffusive reflector 206 may help distribute and diffuse incident signals to cover a larger intended use area. In this way, the coverage area may be less dependent on the angle of an incident beam (e.g., antenna beam 213). Furthermore, the use of diffusive reflector 206 may allow directional antennas 203 and 205 to steer to signals from diffusive reflector 206 rather than seek direct-path signals (i.e., avoiding use of diffusive reflector 206), although the scope of the invention is not limited in this respect.

In some embodiments, directional antenna 203 may be a steerable antenna and may provide a more directive antenna beam, illustrated as antenna beam 213, and directional antennas 205 may be steerable antennas and may provide more directive antenna beams, illustrated as antenna beams 215. In these embodiments, directional antennas 203 and 205 may provide for increased directivity in a direction toward diffusive reflector 206. In these embodiments, the beamwidth of antenna beam 213 may be less than sixty degrees depending on the distance to diffusive reflector 206, although the scope of the invention is not limited in this respect. In some other embodiments, secondary wireless communication devices 204 may utilize a less directive and/or non- steerable antenna beam, although the scope of the invention is not limited in this respect.

In some embodiments, one of the secondary wireless communication devices 204, such as secondary wireless communication device 214, may be a multimedia device such as an HDTV. In these embodiments, wireless communication device 202 may transmit multimedia signals for receipt by wireless communication device 214. In some embodiments, the multimedia signals may be received from an external network. In other embodiments, wireless communication device 214 may generate the multimedia signals internally from digital media. In some embodiments, wireless communication device 214 may be a high-definition display device, although the scope of the invention is not limited in this respect. In some of these embodiments, real-time high-definition video may be streamed from wireless communication device 202 to wireless communication device 214 over the propagation channel using millimeter- wave signals.

In some embodiments, indoor millimeter-wave wireless personal area network 200 may include absorptive elements 212 to reduce receipt of millimeter-wave signals from outside the propagation channel. Absorptive elements 212 may correspond to absorptive elements 112 (FIG. 1). In some embodiments, absorptive elements 212 are optional.

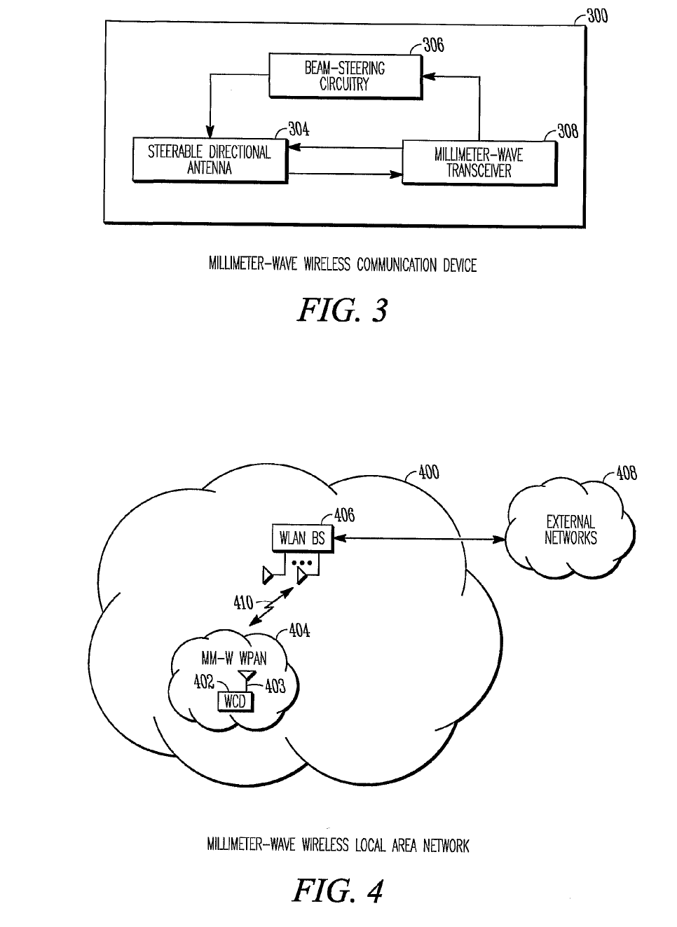

FIG. 3 is a block diagram of a millimeter-wave wireless communication device in accordance with some embodiments of the present invention. Millimeter-wave wireless communication device 300 may be suitable for use as wireless communication device 102 (FIG. 1) and/or wireless communication device 202 (FIG. 2). In some embodiments, millimeter-wave wireless communication device 300 may be suitable for use as secondary wireless communication device 104 (FIG. 1) and/or one or more of secondary wireless communication devices 204 (FIG. 2), although the scope of the invention is not limited in this respect.

Millimeter-wave wireless communication device 300 may include steerable directional antenna 304 coupled with millimeter-wave transceiver 308. Millimeter-wave transceiver 308 may generate millimeter-wave signals for transmission by steerable directional antenna 304. Millimeter-wave transceiver 308 may also process millimeter- wave signals received from steerable directional antenna 304. Steerable directional antenna 304 may correspond to directional antenna 103 (FIG. 1) and/or directional antenna 203 (FIG. 2).

In some embodiments, millimeter-wave wireless communication device 300 may include beam-steering circuitry 306. Beam-steering circuitry 306 may direct an antenna beam, such as antenna beam 113 (FIG. 1) and/or antenna beam 213 (FIG. 2) toward a millimeter-wave reflector, such as reflector 106 (FIG. 1) or diffusive reflector 206 (FIG. 2). In some embodiments, when steerable directional antenna 304 is a chip-lens array antenna or a chip-array reflector antenna with an array of antenna elements, for example, beam-steering circuitry 306 may control an amplitude and/or a phase shift between the antennal elements for directing signals through the millimeter-wave refractive material for steering the antenna beam to reflector 106 (FIG. 1) or diffusive reflector 206 (FIG. 1).

Although millimeter-wave wireless communication device 300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), and combinations of various hardware and logic circuitry for performing at least the functions described herein. In some embodiments, the functional elements of millimeter-wave wireless communication device 300 may refer to one or more processes operating on one or more processing elements.

FIG. 4 illustrates a millimeter-wave wireless local area network in accordance with some embodiments of the present invention. Millimeter-wave wireless local area network 400 may include wireless local area network base station (WLAN BS) 406 and one or more millimeter-wave wireless communication devices, such as wireless communication device (WCD) 402. As illustrated, wireless communication device 402 may operate within millimeter-wave wireless personal area network (MM-W WPAN) 404. Millimeter-wave wireless personal area network 404 may correspond to either millimeter-wave wireless personal area network 100 (FIG. 1) or millimeter-wave wireless personal area network 200 (FIG. 2). Wireless communication device 402 may correspond to wireless communication device 102 (FIG. 1) and/or wireless communication device 202 (FIG. 2). Wireless communication device 402 may include one or more directional antennas 403 which may correspond to directional antenna 103 (FIG. 1) or directional antenna 203 (FIG. 2). In some embodiments, wireless local area network base station 406 may be an access point and wireless communication devices 402 may be mobile stations, although the scope of the invention is not limited in this respect.

In these embodiments, wireless communication device 402 may use directional antenna 403 for communicating with both base station 406 and with secondary wireless communication devices 104 (FIG. 1) using diffusive reflector 106 (FIG. 1) or secondary wireless communication devices 204 (FIG. 2) using reflector 206 (FIG. 2). In some embodiments, an upward directivity of directional antennas 403 may increase the throughput of communications with base station 406, although the scope of the invention is not limited in this respect. In these embodiments, simultaneous operation of wireless local area network 400 and millimeter-wave wireless personal area network 404 may be achieved through frequency division, although other orthogonal communication techniques may also be used. In some embodiments, wireless communication device 402 uses multicarrier communication signals 410 that are non-interfering with the millimeter-wave signals communicated within wireless personal area network 404. In some embodiments, base station 406 may allow wireless communication device 402 to communicate with external networks 408 and/or to communicate with other devices of millimeter-wave wireless local area network 400.

In some embodiments, base station 406 and wireless communication device 402 may communicate using millimeter-wave OFDM communication signals. In some embodiments, base station 406 and wireless communication device 402 may communicate in accordance with a multiple access technique, such as orthogonal frequency division multiple access (OFDMA), although the scope of the invention is not limited in this respect. In some embodiments, base station 406 and wireless communication device 402 may communicate using spread-spectrum signals, although the scope of the invention is not limited in this respect.

In some embodiments, base station 406 may provide communications between wireless communication device 402 and external networks 408. In some embodiments, external networks 408 may comprise almost any type of network such as the Internet or an intranet. In some embodiments, external networks 408 may provide video streaming traffic flows for high-definition video applications. In some embodiments, external networks 408 may include a cable or satellite television network to allow receipt of HDTV signals, although the scope of the invention is not limited in this respect.

In some embodiments, base station 406 may be a Wireless Fidelity (WiFi) communication station. In some other embodiments, base station 406 may be part of a broadband wireless access (BWA) network communication station, such as a Worldwide Interoperability for Microwave Access (WiMax) communication station, although the scope of the invention is not limited in this respect.

In some embodiments, secondary wireless communication device 104 (FIG. 1) and/or secondary wireless communication devices 204 (FIG. 2) may be portable wireless communication devices, such as a personal digital assistant (PDA), a web tablet, a wireless telephone, a wireless headset, a pager, an instant messaging device, a medical device (e.g., a heart rate monitor, a blood pressure monitor, etc.), or other device that may receive and/or transmit information wirelessly.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus, the following claims are hereby incorporated into the detailed description, with each claim standing on its own as a separate preferred embodiment.

What is claimed is:

1. A wireless communication device comprising:
beam-steering circuitry; and
a directional antenna coupled to the beam-steering circuitry, wherein a reflector positioned on either a wall or a ceiling spaced away from the directional antenna reflects millimeter-wave signals communicated between the directional antenna and one or more secondary wireless communication devices of an indoor wireless personal area network.

2. The wireless communication device of claim 1 wherein the directional antenna has a directivity to allow receipt of the millimeter-wave signals through a propagation channel that includes the reflector and to substantially exclude multipath components of the millimeter-wave signals from outside the propagation channel.

3. The wireless communication device of claim 1 wherein the reflector is selected from metallic reflectors, dielectric reflectors comprising dielectric material, dielectric-metallic reflectors comprising a dielectric material with a metallic coating, metallic mesh structures, or dielectric-metallic reflectors comprising a plurality of metallic elements positioned on a dielectric material having a spacing and a length selected to reflect a predetermined millimeter-wave frequency.

4. The wireless communication device of claim 1 wherein the reflector is a diffusive reflector comprising a plurality of half-wavelength dipoles at a predetermined millimeter-wave frequency having a substantially uniform spacing therebetween distributed over a dielectric material, and
wherein the diffusive reflector diffuses and reflects the millimeter-wave signals.

5. The wireless communication device of claim 4 wherein the directional antenna is a steerable directional antenna that is steerable toward the diffusive reflector in response to receipt of the millimeter-wave signals reflected from the diffusive reflector from at least one of the secondary wireless communication devices.

6. The wireless communication device of claim 5 wherein the directional antenna is a chip-lens array antenna comprising a millimeter-wave lens and a chip-array comprising an array of antenna elements, the chip-array to generate an incident beam of millimeter-wave signals, and
wherein the array of antenna elements is coupled to the beam-steering circuitry to direct the incident beam within the millimeter-wave lens for directing the millimeter-wave signals from the directional antenna to the reflector.

7. The wireless communication device of claim 6 wherein the millimeter-wave lens comprises millimeter-wave refractive material disposed directly over the chip-array.

8. A method of communicating within an indoor personal area network comprising:
directing, with a directional antenna coupled to a first wireless communication device, millimeter-wave signals toward a millimeter-wave reflector positioned on either a wall or a ceiling spaced away from the first wireless communication device; and
establishing a propagation channel using millimeter-wave signals utilizing the reflector for communications between the first wireless communication device and one or more secondary wireless communication devices.

9. The method of claim 8 further comprising substantially refraining from receiving multipath components of the millimeter-wave signals directly from the one or more secondary wireless communication devices.

10. The method of claim 9 further comprising steering the directional antenna to receive the millimeter-wave signals through primarily the propagation channel, and
wherein the millimeter-wave reflector comprises a substantially flat metallic plate positioned on either the ceiling or the wall.

11. The method of claim 9 wherein the millimeter-wave reflector is a diffusive reflector, and
wherein the method further comprises diffusing the millimeter-wave signals transmitted by the first wireless communication device with the diffusive reflector for receipt by the one for more secondary wireless communication devices, and
wherein the diffusive reflector comprises a plurality of half-wavelength dipoles at a predetermined millimeter-wave frequency having a substantially uniform spacing therebetween distributed over a dielectric material to diffuse the millimeter-wave signals.

12. The method of claim 11 wherein the directional antenna is a chip-lens array antenna comprising millimeter-wave refractive material and a chip-array comprising an array of antenna elements,
wherein steering comprises the chip-array generating and directing an incident beam of millimeter-wave signals through the millimeter-wave refractive material, and
wherein the millimeter-wave refractive material is either disposed directly over the chip-array or comprises a millimeter-wave lens with a spacing between the chip-array.

13. The method of claim 11 wherein the directional antenna is a chip-array reflector antenna comprising an internal millimeter-wave reflector and a chip-array comprising an array of antenna elements,
wherein steering comprises the chip-array generating and directing an incident beam of millimeter-wave signals at the internal millimeter-wave reflector.

14. The method of claim 8 further comprising streaming real-time video from the first wireless communication device to the secondary wireless communication device over the propagation channel using multicarrier millimeter-wave signals,
wherein the secondary wireless communication device comprises a high-definition display device.

15. A millimeter-wave personal area network comprising:
a diffusive reflector comprising a plurality of dipoles distributed over a millimeter-wave dielectric material to diffuse and to reflect millimeter-wave signals; and
a steerable antenna coupled to a first wireless communication device to direct the millimeter-wave signals toward the diffusive reflector for receipt by a secondary wireless communication device.

16. The network of claim 15 wherein the dipoles comprise substantially half-wavelength dipoles at a predetermined millimeter-wave frequency,
wherein the steerable antenna comprises an array of antenna elements and either an millimeter-wave reflector or millimeter-wave refractive material, and
wherein the first wireless communication device comprises beam steering circuitry to control the array of antenna elements to direct an incident beam either at the millimeter-wave reflector or through millimeter-wave refractive material for direction to the diffusive reflector.

17. The network of claim 16 wherein when the steerable antenna comprises millimeter-wave refractive material, the millimeter-wave refractive material comprises a millimeter-wave lens to narrow a beamwidth of the incident beam generated by the array of antenna elements.

18. The network of claim 16 wherein the millimeter-wave signals comprise multicarrier signals ranging between approximately 57 and 90 Gigahertz (GHz) and include an extended guard interval.
